(19) United States
(12) Patent Application Publication
(10) Pub. No.: US 2007/0005194 A1
(43) Pub. Date: Jan. 4, 2007

(54) System for three-phase voltage detection and protection

(76) Inventors: Liuchen Chang, Fredericton (CA); Qingrong Zeng, Mississauga (CA)

Correspondence Address: KRIEG DEVAULT LLP, ONE INDIANA SQUARE, SUITE 2800, INDIANAPOLIS, IN, 46204-2079, US

(21) Appl. No.: 11/471,315

(22) Filed: Jun. 20, 2006

Related U.S. Application Data
(60) Provisional application No. 60/691,784, filed on Jun. 20, 2005.

(51) Int. Cl. G05D 11/00

(52) U.S. Cl. 700/292

(57) ABSTRACT

A method of system for three-phase voltage detection wherein the magnitude of a grid voltage is calculated using a grid voltage vector derived from the grid voltage using Park Transformation and then compared to a predetermined voltage threshold is disclosed.

### CROSS REFERENCE

This application claims priority from and benefit to U.S. provisional patent application Ser. No.: 60/691,784 filed on Jun. 20, 2005, which is hereby incorporated by reference in its entirety.

### FIELD OF THE INVENTION

The present invention relates generally to the field of grid-connected inverter systems and more particularly, to a method and system for three-phase (3-phase) voltage detection.

### BACKGROUND OF THE INVENTION

Reliable, fast and accurate voltage detection is critical for the safety and protection of distributed power generators (DC) as well as power systems.

A distributed power generation system is required to cease energizing the grid within a specified clearing time at the detection of an abnormal grid voltage. Traditionally, three-phase grid voltage protection is achieved by calculating and monitoring RMS values of grid voltages from the instantaneous voltage data. However, this requires continuously accumulating the sampled voltage data over one or more cycles before an RMS value is calculated, which not only demands lengthy computations but also causes a time delay in response to a voltage fault.

According to IEEE standards for DC interconnection, the RMS or fundamental frequency values of line-to-line voltages of an ungrounded three-phase system, or phase-to-neutral voltages of a grounded wye-wye three-phase system, or phase-to-neutral voltages of a single-phase system, shall be detected for abnormalities. Traditionally, the RMS voltage is detected based on equation (1):

$${V}_{rms} = \sqrt{\frac{{\int }_{{t}_{0}}^{{t}_{0} + T} {v}^{2} ( t ) ⅆ t}{T}} \qquad ( 1 )$$

where v(t) is the instantaneous value and T is the period of grid voltages. In practice, the above RMS calculation method has certain challenges in implementation. The discrete values of v(t) or v2(t) at the sampling moments need to be accumulated continuously over one or more cycles, which requires both large computational time and storage resources. This causes an inevitable delay in response to an over-voltage or under-voltage fault.

### SUMMARY

In one aspect, the present invention provides a method and system in which the continuous accumulation over time is no longer necessary, and the dynamic response to a grid voltage fault is substantially improved by a method for three-phase grid voltage detection and protection based on voltage reference frame transformation on a three-phase grid-connected inverter, based on calculation and monitoring of the instantaneous magnitude of the grid voltage vector in the synchronous d-q reference frame. Analysis shows that the magnitude of the grid voltage vector can reflect the dynamic characteristics of grid voltages instantaneously, thus the response for grid voltage faults is immediate. In addition, the method is direct and simple. The results of both simulations and laboratory tests on the inverter have verified that the new method is simple and accurate, and offers a fast dynamic performance.

In another aspect, the present invention provides, a method of three-phase voltage detection and protection, where the magnitude of grid voltage vector in the synchronous d-q reference is monitored instead of RMS value of grid line-to-line voltages in the A-B-C reference frame. The magnitude of grid voltage vector is calculated from the present instantaneous values of grid phase voltages based on Park Transformation.

In another aspect, the present invention provides, a method of three-phase voltage detection in a distributed power generation system comprising the steps of calculating the magnitude of a grid voltage vector using Park Transformation and monitoring the magnitude in real-time and comparing the magnitude with preset protection limits.

In another aspect, the present invention provides, a method of three-phase voltage detection in a power gird comprising the steps of sampling a three-phase voltage input and grid angle from the power grid, transforming the three-phase voltage input to a two phase coordinate system and deriving a grid voltage vector, determining the magnitude of the grid voltage vector, and comparing the magnitude with a predetermined threshold value. The method can further include generating a system control command when the magnitude exceeds the predetermined threshold value and applying the command to initiate protection and control functions in the grid.

In another aspect, the present invention provides, a voltage detection system comprising a three-phase transformer for reducing the three phase input voltage, a microprocessor connected to the three-phase transformer comprising an A/D converter for digitizing analog voltage signals into digital signals, a phase sequence and grid detection circuit for detecting for detecting grid phase sequence and grid angle, a three-phase to two-phase conversion and magnitude calculation program for (1) conducting voltage reference frame transformation from three phase to two phase (2) calculating the magnitude of voltage vectors derived from the transformation and (3) comparing the magnitude of the voltage vectors to predetermined thresholds, and one or more protection and control devices connected to the microprocessor.

### BRIEF DESCRIPTION OF THE DRAWINGS

The components in the figures are not necessarily to scale, emphasis instead being placed upon illustrating the principles of the invention. Moreover, in the figures, like reference numerals designate corresponding parts throughout the different views.

FIG. 1 is a vector diagram for the case when a positive-sequence harmonic component exists in a grid voltage;

FIG. 2 is a vector diagram for the case when a negative-sequence harmonic component exists in a grid voltage;

FIG. 3 is a block diagram of a grid voltage detection and protection system;

FIG. 4 is a hardware circuit for three-phase voltage detection;

FIG. 5 shows a transformation from A-B-C coordinates to α-β coordinates;

FIG. 6 shows a transformation from α-β coordinates to d-q coordinates;

FIG. 7 shows simulation results of the case when a 7^{th} harmonic voltage exists in the grid. Upper: magnitude of grid vector voltage (V); Lower: Phase-A voltage (V);

FIG. 8 shows simulation results of the case when a 5^{th} harmonic voltage exits in the grid. Upper: magnitude of gird vector voltage (V); Lower: Phase-A voltage (V);

FIG. 9 shows a simulated waveform of the magnitude of grid voltage vector in case of phase-loss fault;

FIG. 10 shows a simulated waveform of the magnitude of grid voltage vector in case of single line-to ground fault;

FIG. 11 shows a simulated waveform of the magnitude of grid voltage vector in case of a line-to-line fault;

FIG. 12 shows a simulated waveform of the magnitude of grid voltage vector in case of a double line-to ground fault;

FIG. 13 shows the waveforms of the magnitude of grid voltage vector and Phase-A voltage. Upper: magnitude of grid voltage (V); Lower: Phase-A voltage (V); Time: 16.67 us/digit;

FIG. 14 shows a test on Phase-C over voltage fault. The spikes at the grid voltages show the de-activation of the inverter connected with the grid. Upper: Grid fault signal (active high); Lower: Three phase voltages (100V/div); Time: 5 ms/div;

FIG. 15 shows a test on Phase-C voltage fault. The spikes at the grid voltages show the de-activation of the inverter connected with the grid. Upper: Grid fault signal (active high); Lower: Three phase voltages (100V/div); Time: 5 ms/div;

FIG. 16 shows the waveform in d-q coordinates in the case shown in FIG. 10. Upper: magnitude of grid voltage vector (V); Middle: grid voltage in d axis (V); Lower: grid voltage in q axis (V); time: (sec);

FIG. 17 shows the waveforms in d-q coordinates in the case shown in FIG. 11. Upper: magnitude of grid voltage vector (V); Middle: grid voltage in d axis (V); Lower: grid voltage in q axis (V); Time: (sec);

FIG. 18 is a system block diagram of a voltage detection and protection system according to the invention; and

FIG. 19 is a flow chart showing a computer-implemented method according to the present invention.

### DETAILED DESCRIPTION

For the purposes of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated device, and such further applications of the principles of the invention is illustrated therein being contemplated as would normally occur to one skilled in the art to which the invention relates.

According to the principles of Park Transformation, three-phase balanced sinusoidal signals in the stationary A-B-C reference frame can be transformed into a static vector in the synchronous d-q reference frame, and the magnitude of this vector is exactly equal to the peak value of the sinusoidal signal. Since the actual grid voltage is generally non-sinusoidal due to harmonic components, the corresponding vector will have a slightly variable magnitude whose ripple frequency magnitudes and (or peak-to-peak value) depend on the harmonic components in the grid voltage. In a three-phase system, the grid voltage can be decomposed into positive-sequence components, negative-sequence components and zero-sequence components at each harmonic frequency.

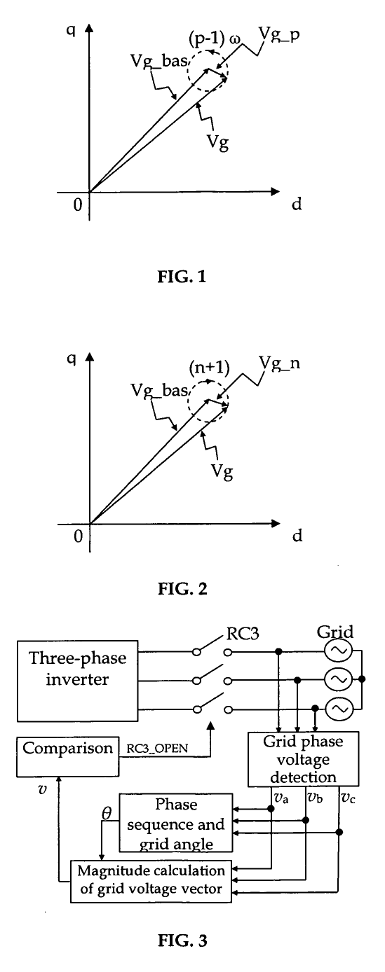

FIG. 1 is a vector diagram for the case when a positive sequence harmonic component exists. As shown in FIG. 1, if the fundamental voltage vector in the d-q frame is Vg_base and is superimposed by a p^{th} positive-sequence harmonic component voltage vector Vg_p, the actual grid voltage vector Vg is the compound vector of Vg_base and Vg_p. The p^{th} harmonic voltage vector rotates in the positive direction of the d-q frame at p times the synchronous angular frequency ω. Thus in the d-q frame, Vg_p rotates at a relative velocity of (p−1) ω. As a result, the voltage vector Vg forms a locus of a circle whose radius is the magnitude of Vg_p, as shown in FIG. 1.

Similarly, FIG. 2 shows the case when there is a negative-sequence n^{th} harmonic component in the grid voltage. The rotating direction of Vg_n here is in the opposite direction at a velocity of (n+1)ω. Since there is no zero-sequence component in the line-to-line grid voltages of a three-phase system, zero-sequence components can be ignored.

Grid voltage faults will cause an obvious change in the magnitude of the grid voltage vector, because both balanced faults and unbalanced faults will change the components of fundamental and harmonic voltages of the grid. That is, Vg reflects not only the RMS value of the fundamental voltage but also the harmonic components in the grid voltages. Therefore, monitoring the instantaneous magnitude of a grid voltage vector presents simple yet effective method for grid voltage detection and protection.

FIG. 3 shows a block diagram of a grid voltage detection and protection system. Through an output contactor RC3, a three-phase inverter is connected to a three-phase power grid without neutral line. The equivalent phase voltages of the three-phase three-line grid va, vb and vc, are detected and used to calculate the magnitude of the grid voltage vector, vg. Moreover, the grid phase voltage signals are also used to detect the grid phase sequence and the grid angle θ by zero-crossing detection and a software pass-lock-loop (PLL), where the grid phase sequence will determine the rotating direction of the d-q coordinate, i.e. the sign of θ. At the same time, the grid frequencies of each phase are also detected and monitored from the three phase voltage signals, which is another important part of the system protection but not shown in FIG. 3. The magnitude of grid voltage vector is calculated using Park Transformation, then monitored in real-time and compared with the protection limits that are preset according to the IEEE interconnection standards. Once the magnitude of the grid voltage vector exceeds its limits, the grid voltage faults protection is activated immediately to disable the operation of the three-phase inverter and to, at the same time, disconnect the converter from the grid by opening the output contactor RC3.

Most of three-phase grid-connected inverters are connected to a three-phase grid without a neutral, which means the phase-to neutral voltage cannot be directly measured. In these cases, line-to-line voltages can be detected instead of according to the IEEE standards. However, for high performance inverters, the grid phase voltages are usually required for the control algorithm as the signal of the back EMF. Therefore, it is preferred to design a circuit to detect the equivalent phase voltages of the grid for both system protection and control algorithm.

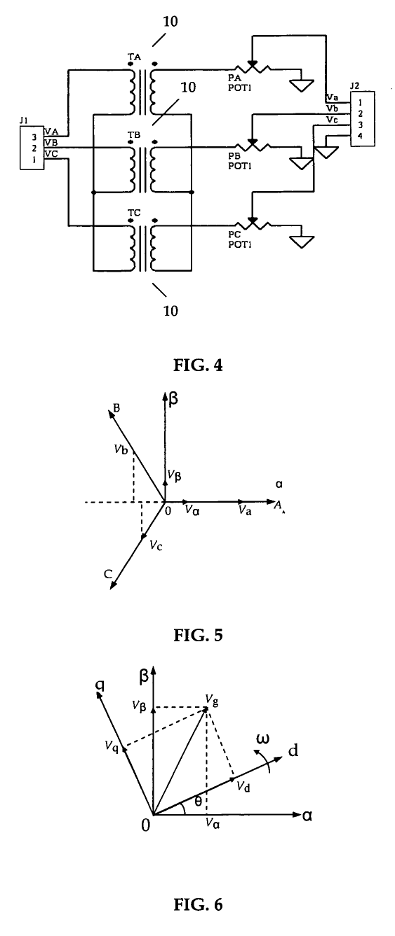

Three single-phase transformers 1A, 1A and 1C are employed to detect the phase voltages of the three-phase grid. As shown in FIG. 4, three transformers are Y-Y connected without neutrals, and three detection potentiometers are also Y-connected as the three-phase load of the three transformers. The three-phase grid voltages, VA, VB and VC are input through the connect J1, while the detected three voltage signals, Va, Vb and Vc are sent out through the connecter J2 for the further calculation. As will be obvious to those skilled in the art, as long as three potentiometers PA, PB, and PC have the same resistance, their common point, the signal ground in FIG. 4 is the desired neutral point, and Va, Vb, Vc can be considered as the equivalent phase-voltage signals of the three-phase grid. Zero-sequence voltages will not appear in the phase voltage signals, but since there are no zero-sequence voltages existing in line-to-line voltages of a three-phase three-wire grid, this circuit is still valid for the detection of the grid phase voltages.

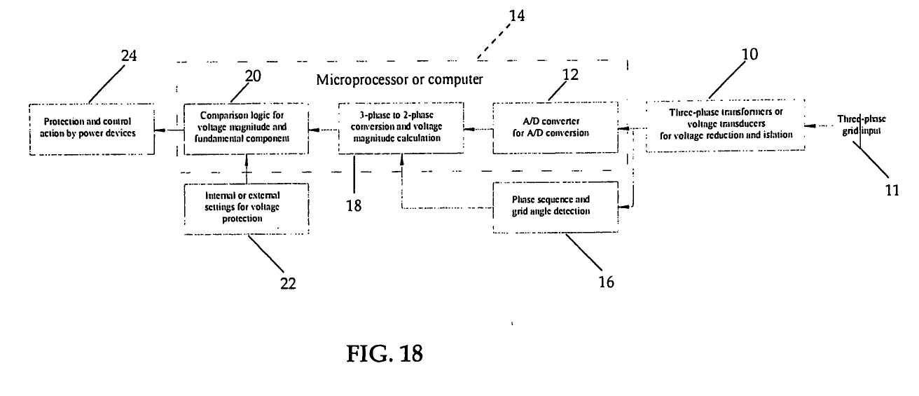

Referring to FIG. 18, a system for implementing the invention is shown. Three-phase transformer or voltage transducers 10 reduce the voltage and provide isolation between the high voltage power system 11 and the low voltage protection/control circuit. An A/D converter 12 digitizes the analog voltage signals into digital signals for the microprocessor 14. A phase sequence and grid angle detection circuit 16 detects the grid phase sequence and grid angle for reference frame transformation from 3-phase to 2-phase. A 3-phase to 2-phase conversion and magnitude calculation block 18 conducts voltage reference frame transformation from 3-phase to 2-phase and calculates the magnitudes of the voltage vector and the fundamental components. A comparison logic 20 compares the detected magnitudes of the voltage vector and the fundamental components with those of Internal or external settings 22 for voltage protection, and activates conventional protection and control action by power devices 24. It is also possible to modify a conventional voltage detection system by making an appropriate software modification to implement to method of the present invention.

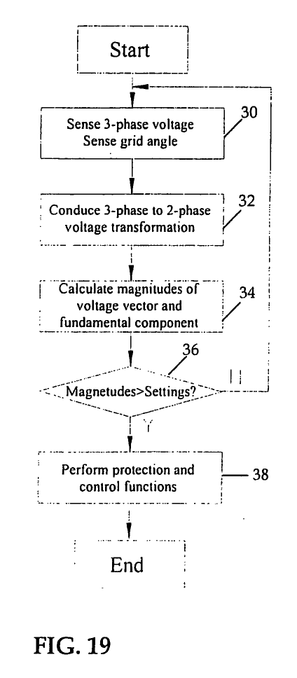

A program flow chart is shown in FIG. 19 which shows the steps carried out by the microprocessor 14 in the system of FIG. 18 as follows: step 30, sense 3-phase voltage and sense grid angle, step 32, conduct 3-phase to 2-phase voltage transformation, step 34, calculate magnitudes of voltage vector, step 36, compare the magnitude with the settings. If the magnitude is equal to or less than the settings, go to step 30. If the magnitude is greater than an upper voltage threshold value or lower than a lower voltage threshold value, go to step 38. Step 38, perform protection and control functions if protection and control conditions are met.

In step 30, the 3-phase grid voltages (vₐ, v_{b}, and v_{c}) are sensed by the A/D converter 12 of the microprocessor 14, the phase sequence and grid angle (θ) are sensed through the zero-crossing pulses provided by the external circuits 16.

The calculation of the magnitude of grid voltage vector is based on Park Transformation which is utilized to transfer grid phase voltages from three-phase stationary A-B-C coordinates to two-phase synchronous rotating d-q coordinates. In order to simplify the computation, the transformation is conducted in two steps.

The first step of step 32 is to transfer grid voltages from the conventional three (3)-phase stationary coordinate system (A-B-C coordinates) to the two (2)-phase stationary coordinate system (α-β coordinates), where α-axis is oriented to the direction of A-axis of ABC coordinates, as shown in FIG. 5. Equation (2) illustrates the equation of the transformation, where [v_{α}v_{β}]^{T} is the grid voltage vector in a α-β coordinates:

$$[ \begin{matrix}{v}_{α} \\ {v}_{β}\end{matrix} ] = \frac{2}{3} [ \begin{matrix}1 & - \frac{1}{2} & - \frac{1}{2} \\ 0 & \frac{\sqrt{3}}{2} & - \frac{\sqrt{3}}{2}\end{matrix} ] [ \begin{matrix}{v}_{a} \\ {v}_{b} \\ {v}_{c}\end{matrix} ] \qquad ( 2 )$$

The second step of step 32 is to transfer grid voltages from the stationary α-β coordinate system to the two-phase rotating coordinate system (d-q coordinates) as shown in FIG. 6, where the d-q coordinates rotate at the same speed as the grid fundamental frequency ω and in either the counter clockwise direction in case of positive grid phase sequence or the clockwise direction in case of negative grid phase sequence. FIG. 6 shows the transformation in the case of positive grid phase sequence. Equation (3) illustrates the equation of the transformation, where θ is defined as the grid angle between d-axis of d-q coordinates and α-axis of α-β coordinates (or A-axis of A-B-C coordinates) and is equal to ω t and, [v_{d}v_{q}]^{T} is the grid voltage vector in d-q coordinates.

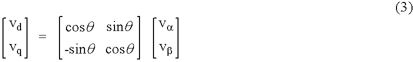

In step 34, once the grid voltage vector in d-q coordinates is found out, the magnitude of the grid voltage vector, vg is calculated using equation (4):
v_{g}=\sqrt{v_{d}²=v_{q} ²} (4)

The average value of the grid voltage vector magnitude, (approximately equal to the fundamental grid voltage magnitude) v_{g1}, needs to be calculated and monitored for the protection purpose. A simple software RC filter is employed to extract v_{g1} from v_{g}, as described by equation (5) in a processor. Once a in equation (6) and system sampling period T are known, the time constant of the filter, τ, can be determined by equation (5):
V_{g1}(k)=(1−α)V_{g1}(k−1)+αV_{g}(k)) (5)

where V_{g}(k) is the present sampling value of v_{g}; V_{g1}(k) is the latest filtered value of v_{g}; V_{g}(k−1) is the last filtered value of v_{g}; α is the filter smoothness coefficient.

$$τ = \frac{T}{{ln ( 1 - α )}^{- 1}} \qquad ( 6 )$$

In step 36, the detected voltage vector magnitude and fundamental component magnitude are then compared with the protection settings which can be given by the internal data in the processor or by the external data sent from the external system through A/D conversion or digital communication means. The results of comparison are used to perform protection functions or used to perform conventional control functions of the system.

In step 38, the performance of protection functions and control functions is done by external execution devices based on the detected voltage vector magnitude and fundamental component magnitude, and normally done at a power level.

A program using the method of the present invention is normally run in a cyclical manner in a protection and control system.

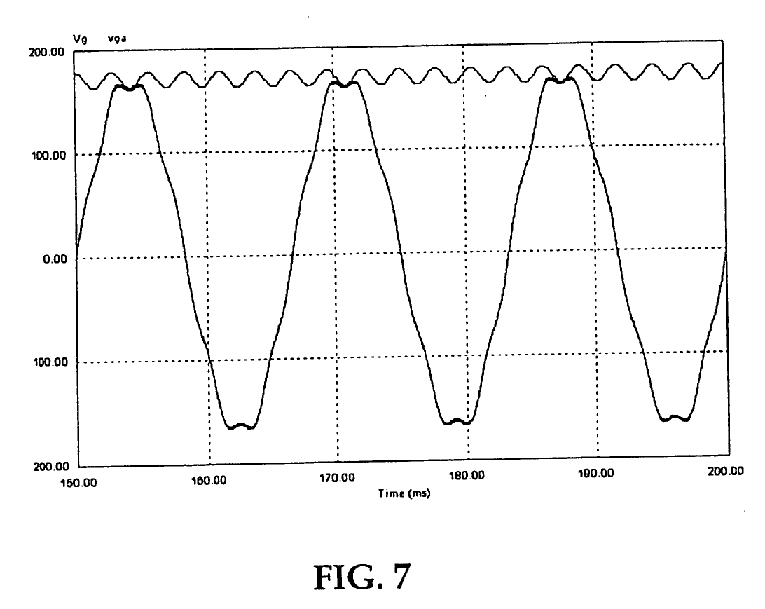

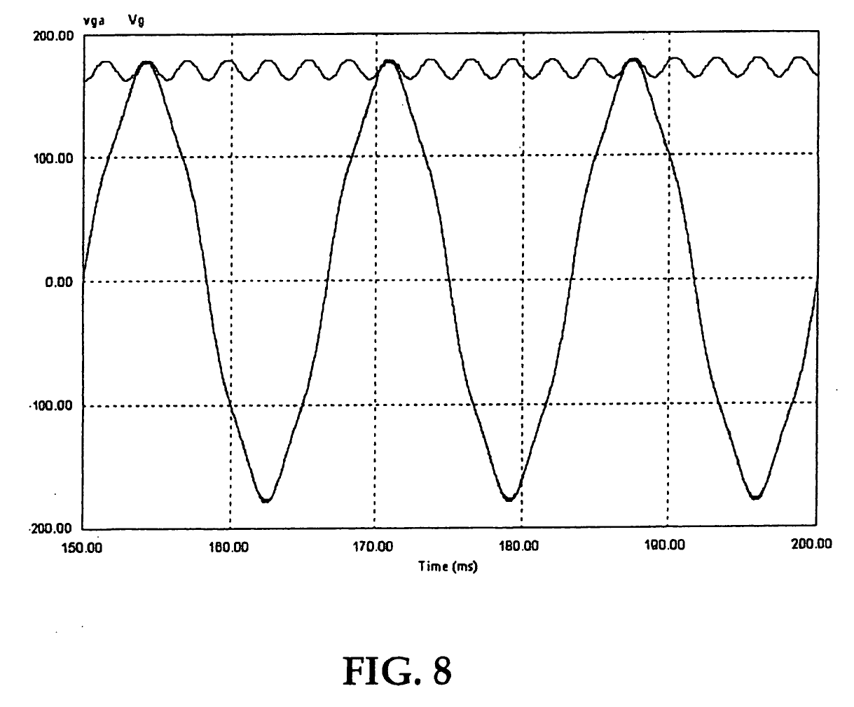

In order to verify the above analyses shown in FIG. 1 and FIG. 2, a three-phase grid system was simulated by the present inventors using PSIM simulation package. FIG. 7 shows the simulation results of the case when there is a 7^{th} harmonic component in the three-phase grid voltage. Here the fundamental frequency component is 170sin(1207πt) and the 7^{th} harmonic component is 8sin(840πt) which is a positive-sequence component. FIG. 7 confirms that the simulation result agrees with the analysis shown in FIG. 1. Similarly, FIG. 8 shows the simulation results of the case when there is a 5^{th} harmonic component in the three-phase grid voltage. The fundamental frequency component is 170sin(120πt) while the 5^{th} harmonic component is 8sin(600πt) which is a negative-sequence component. Also, the simulation results verify the analysis shown in FIG. 2.

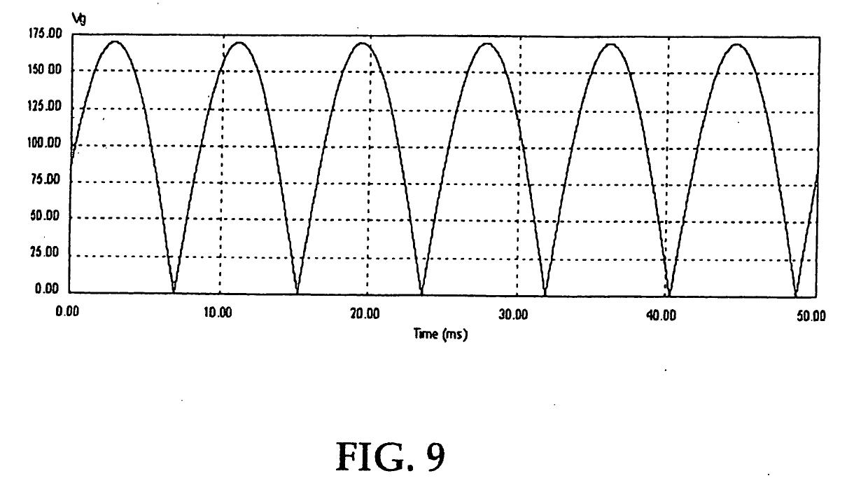

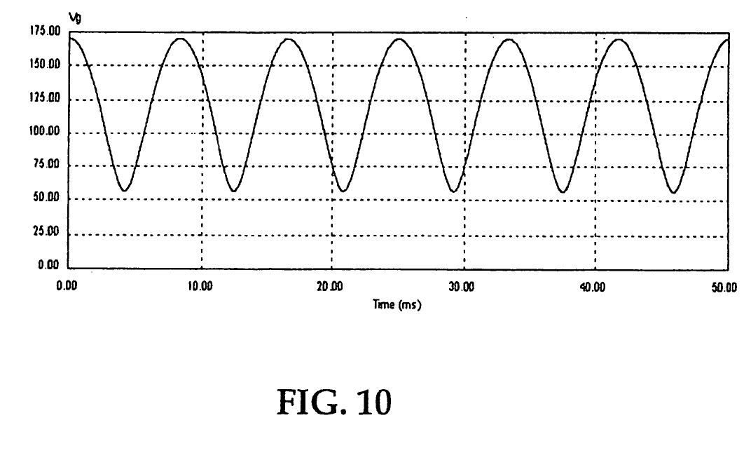

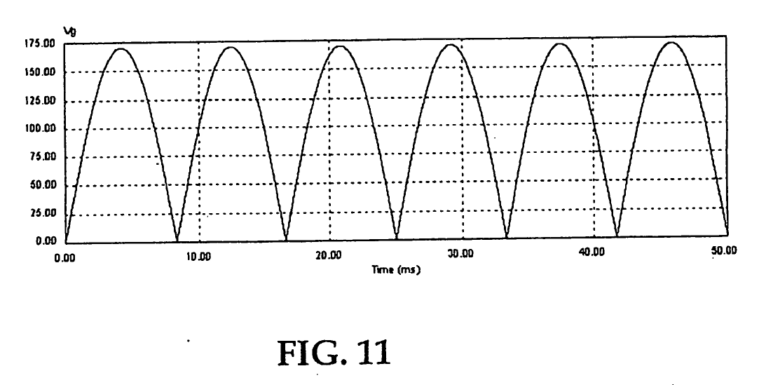

Four typical grid unsymmetrical faults, namely phase-loss fault, single line-to-ground fault, line-to-line fault and double line-to-ground fault, are also simulated in this paper, and the simulated waveforms of the magnitude of grid voltage vector are shown in FIG. 9 to FIG. 12, respectively. The simulation is based on the phase voltage detection circuit shown in FIG. 3, and the nominal line-to-line voltage of the three-phase grid is 208V without any harmonics. From the simulation results, it can be seen that all unsymmetrical faults mainly introduce a negative-sequence component to the fundamental frequency voltage, which causes the magnitude of the grid voltage vector to oscillate with a frequency twice of the fundamental frequency.

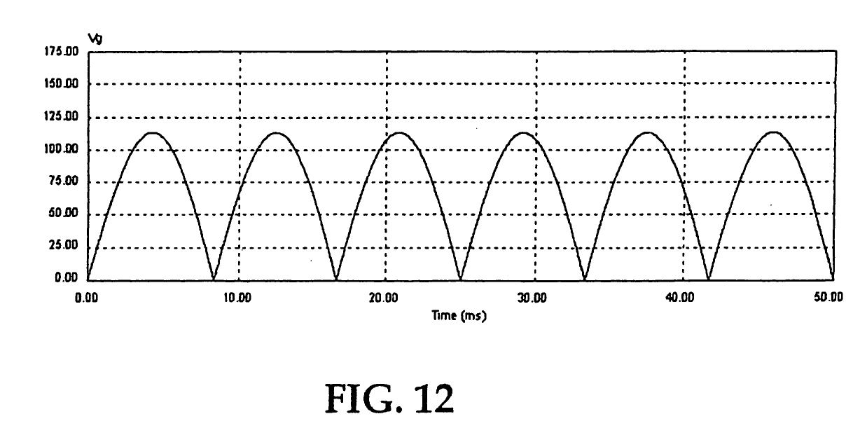

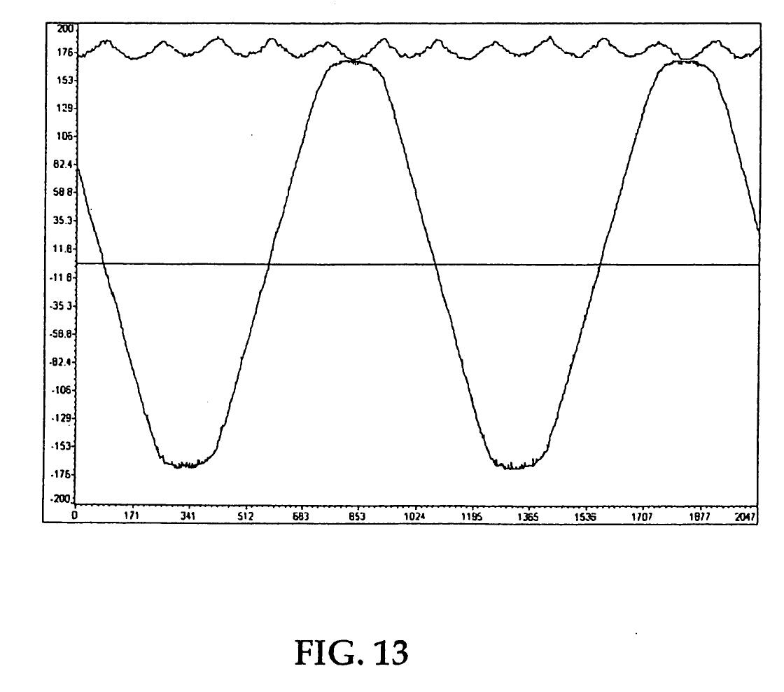

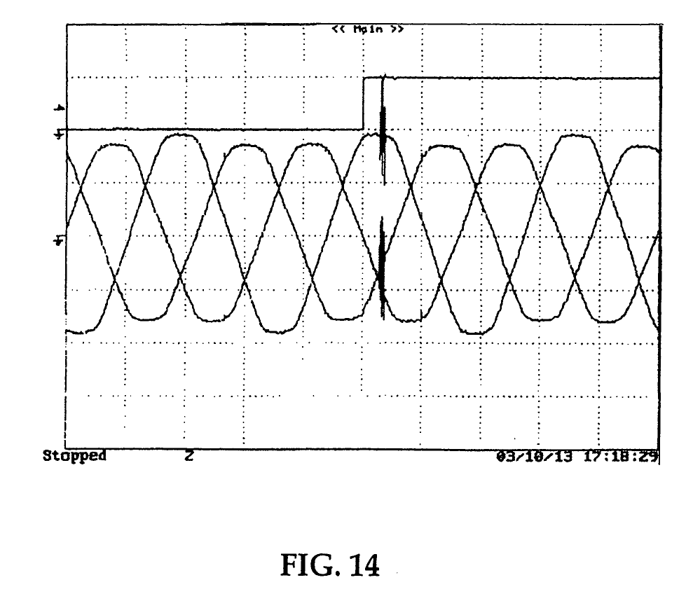

The present inventors successfully tested the grid voltage detection and protection method according to the present invention by implementing it in a 30 kW three-phase grid-connected inverter used for a variable speed small hydro system. In laboratory tests, the nominal line-to-line voltage of the grid is 208V and the nominal grid frequency is 60 Hz. FIG. 12 shows the waveforms of phase-A voltage and the magnitude of grid voltage vector in the d-q frame. It can be seen that the magnitude of the fundamental voltage is about 175V and the dominant harmonic components of this grid are 5^{th} and 7^{th} harmonic voltages.

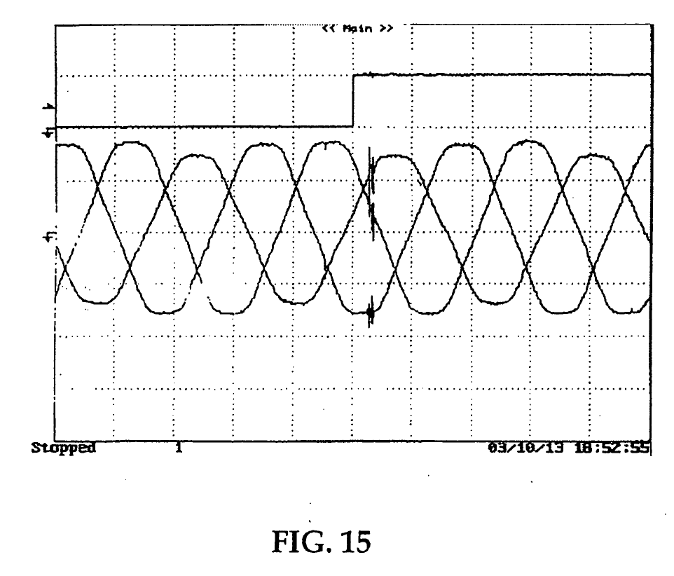

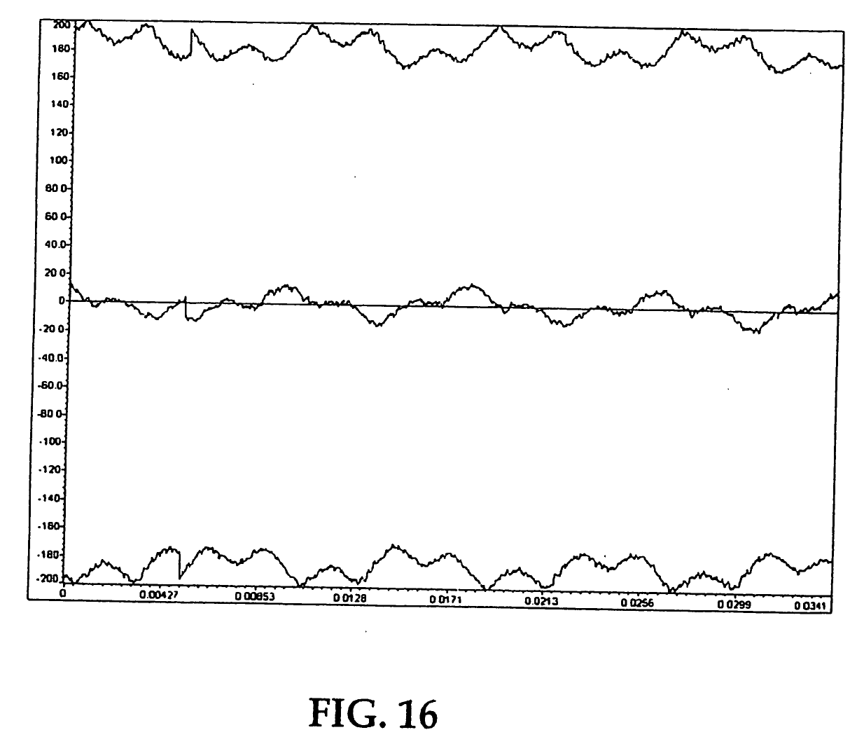

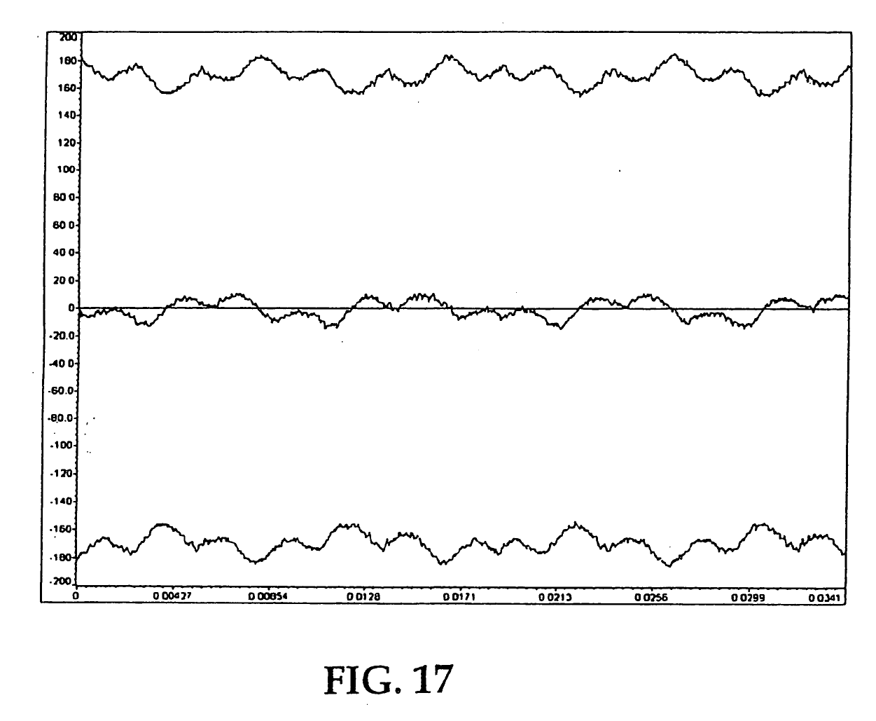

Unbalanced voltage faults were also tested in the laboratory. Gains in the phase voltage detection circuits are adjusted to simulate Phase-C over-voltage and under-voltage faults. As shown in FIG. 14 and FIG. 15, once Phase-C voltage reaches the upper or lower protection limit, the fault protection signal activates immediately, thus eliminated the delay caused by RMS detection by traditional methods. FIG. 16 and FIG. 17 show the corresponding variables in the d-q frame.

While the invention has been illustrated and described in detail in the drawings and foregoing description, the same is to be considered as illustrative and not restrictive in character, it being understood that only the preferred embodiments have been shown and described and that all changes and modifications that come within the spirit of the inventions are desired to be protected. It should be understood that while the use of words such as preferable, preferably, preferred or more preferred utilized in the description above indicate that the feature so described may be more desirable, it nonetheless may not be necessary and embodiments lacking the same may be contemplated as within the scope of the invention, the scope being defined by the claims that follow. In reading the claims, it is intended that when words such as “a,” “an,” “at least one,” or “at least one portion” are used there is no intention to limit the claim to only one item unless specifically stated to the contrary in the claim. When the language “at least a portion” and/or “a portion” is used the item can include a portion and/or the entire item unless specifically stated to the contrary.

What is claimed is:

1. A method of three-phase voltage detection in a distributed power generation system, comprising the steps of:
calculating a magnitude of a grid voltage vector using Park Transformation; and
monitoring the magnitude in real-time and comparing the magnitude with preset protection limits.

2. A method of three-phase voltage detection, comprising the steps of:
sampling a three-phase voltage input and grid angle from a power grid;
transforming the three-phase voltage input to a two phase coordinate system and deriving a grid voltage vector;
determining a magnitude of the grid voltage vector; and
comparing the magnitude with a predetermined threshold value.

3. The method of claim 2, further comprising the step of generating a system control command when the magnitude exceeds the predetermined threshold value.

4. The method of claim 3, further comprising the step of applying the system control command to initiate protection and control functions in the power grid.

5. A voltage detection system, comprising:
a three-phase transformer for reducing a three-phase input voltage;
a microprocessor connected to the three-phase transformer, comprising:
an A/D converter for converting analog voltage signals into digital signals;
a phase sequence and grid detection circuit for detecting a grid phase sequence and grid angle;
a three-phase to two-phase conversion and magnitude calculation program for (1) conducting voltage reference frame transformation from three-phase to two-phase (2) calculating a magnitude of voltage vectors derived from the transformation and (3) comparing the magnitude of voltage vectors to predetermined thresholds; and
at least one protection and control device connected with the microprocessor.

6. A method of three-phase voltage detection, comprising the step of monitoring the instantaneous magnitude or grid voltage vector.

7. The method of claim 6, wherein the grid voltage vector is in a synchronous reference frame.

8. The method of claim 7, further comprising the step of using Park Transformation to determine a magnitude of the grid voltage vector from instantaneous values of grid phase voltages.

9. The method of claim 8, wherein the Park Transformation includes the steps of transferring grid voltages from a three-phase to a two-phase stationary coordinate system and transferring the grid voltages from the two-phase stationary coordinate system to a two-phase rotating coordinate system.

10. A method of detecting an abnormal voltage in a grid, comprising the steps of:
sampling three-phase grid voltage values and associated phase sequence and grid angle values, and
calculating a magnitude of a grid voltage vector from the sampled values.

11. The method of claim 10, wherein the step of calculating the magnitude of the grid voltage vector includes the step of performing a Park Transformation.

12. The method of claim 11, wherein the Park Transformation is performed in two steps and wherein the grid voltage values are represented as grid voltage vectors in a three-phase stationary coordinate system.

13. The method of claim 11, wherein one of the two steps includes transforming the grid voltage vectors from the three-phase stationary coordinate system to a two-phase stationary coordinate system.

14. The method of claim 13, wherein the other of the two steps includes transforming the grid voltage vectors in the two-phase stationary coordinate system to a two-phase rotating coordinate system.

15. The method of claim 14, wherein the step of calculating the magnitude of the grid voltage vector by taking the square root of the sum of the squares of the grid voltage vectors in the two-phase rotating coordinate system.

16. The method of claim 15, further including the step of calculating the average value of the grid voltage vector magnitude.
